(19) United States
(12) Patent Application Publication
(10) Pub. No.: US 2006/0277248 A1
(43) Pub. Date: Dec. 7, 2006

(54) Configuration-based application architecture using XML/XSLT

(76) Inventors: Eugene E. Baxter, Farmington Hills, MI (US); Mark W. Brown, Farmington Hills, MI (US)

Correspondence Address: KOHN & ASSOCIATES PLLC, 30500 NORTHWESTERN HWY, STE 410, FARMINGTON HILLS, MI, 48334, US

(21) Appl. No.: 11/433,134

(22) Filed: May 12, 2006

Related U.S. Application Data
(60) Provisional application No. 60/680,136, filed on May 12, 2005.

(51) Int. Cl. G06F 15/16

(52) U.S. Cl. 709/201

(57) ABSTRACT

A system for processing a request, the system includes a request initiator for creating a request, a request receiver for receiving the request from the request initiator, wherein the request receiver is in communication with the request initiator, and data structuring device for sequencially structuring data for use in processing the request and providing a response to the request. A method of processing a request by creating a request, forwarding the request to a request processing system, receiving the request, processing the request, processing the output of the request, and providing a response to the request.

### CROSS-REFERENCE TO RELATED APPLICATIONS

This application claims the benefit of priority under 35 U.S.C. Section 119(e) of U.S. Provisional Patent Application No. 60/680,136, filed May 12, 2005, which is incorporated herein by reference.

### BACKGROUND OF THE INVENTION

1. Field of the Invention

The present invention relates to the field of internet applications and software. Specifically, the present invention relates to systems and methods towards creation of any application whereby data is processed, retrieved, stored and subsequently displayed.

2. Description of the Related Art

Through computer networks such as the Internet, businesses and individuals are able to create Web Sites that serve as an audio/visual medium to deliver information to users browsing the Web Site. Websites can be built and customized to the individual needs of the creator.

Web sites can be intricate and require thousands of hours to develop. Businesses and individuals incur great costs in this process and dedicate a great number of people towards the Website's development and maintenance.

The web pages may contain text, graphics, images, sound, video, etc. and are generally written in a standard page or hypertext document description language known as the Hypertext Markup Language (HTML). The HTML format allows a web page developer to specify the location and presentation of the graphic, textual, sound, etc. on the screen displayed to the user accessing the web page.

H. Pajak, Electronic Library, European Patent Application No. 472070 (filed Aug. 9, 1991) discloses an electronic library metaphor on a computer workstation that includes shared books with data base metaphor, a reference books metaphor, and a card catalog metaphor in one system that allows large object oriented data base be organized and accessed in an exclusive environment and that allows access to screen icons, creates a visual hierarchy of related and shared objects, and allows mutually exclusive access to the metaphors within the library.

S -Y Hsu, Process For Identifying Simple and Complex Objects From Fused Images And Map Data, U.S. Pat. No. 5,631,970 (May 20, 1997) discloses a method of identifying and/or extracting an object from multiple fused information sources, such as amps and images. The system allows a user to integrate information freely from multiple sources, such as maps, socioeconomic data, and various types of images. Data is first retrieved and then processed to transform its pixel representation to a region representation. The region representation is then refined by merging mechanisms, such as segmentation. The identified and/or extracted object can then be visualized by the user. Features or objects can then be extracted using the user's expert rules and confidence levels, which confidence levels may be derived by fuzzy logic.

An Information Retrieval System, European Patent Application No. 774722 (filed Nov. 15, 1996) discloses a system in which design and content are separated. In this system, an information retrieval server (IR) indexes and searches stories in titles. Indexing takes place when a title is released to the network by a publisher workstation. The IR server inter-relates title, section, and story objects by their globally unique identifiers and creates a routing table which is used to located objects across multiple database partitions. The IR search service is requested in two different way at customer runtime. The first way is the resolution of the search objects to retrieve matching stories. The retrieved stories are concatenated and poured into the area defined by the dynamic control when the title is viewed. In the second way, the IR search service is requested when a search is initiated by a customer using a “find” dialog to search across all stories in one or more titles, both dynamic and static.

Typically, such searching systems utilize a two-tier enterprise information system (EIS). In an EIS a server tier stores and manages enterprise data, while a client tier provides a user interface to the data in the server tier. A conventional client tier also is responsible for implementing most of the business logic or data processing. In general, a client and a server rely on a request/response model for communicating with each other, in which the client sends a request (for data or other resources) to a server, and the server responds to the client. Note that, in this context, the terms “client” and “server” refer to the hardware and software, collectively, that implement each tier's respective functions. The client, though, generally is a distinct physical entity that is remotely connected to the server through a network. A classic embodiment of the two-tier architecture is when a client provides the user interface and business logic, and a database server maintains the enterprise data and processes a client's request to retrieve or update the data. More particularly, two-tier client/server architecture has a server tier in the form of server that stores and manages enterprise data stored in database. A client tier in the form of client provides user interface for viewing and manipulating data maintained by server. Client is also responsible for implementing most of the business logic required for data processing. Server processes request to retrieve or update the data in database and sends response to client.

Although the two-tier architecture has enjoyed much success over the years, sophisticated multi-tier client/server systems slowly have displaced this traditional model. A multi-tier system places at least one intermediate (or “middleware”) component between client and server. Generalized “n-tier” systems include n layers of software that provide a different layer of services at varying levels of detail to the layers above and beneath them, where n is any number. While the client tier generally retains its traditional responsibility for implementing user interface, one or more middle tiers implement business logic, a middleware component that implements business logic is commonly referred to as an “application server.” Additional tiers usually implement the traditional server tier functions, which include data management and retrieval.

Web server technology continued to evolve as well, and eventually embraced techniques for dynamically generating web pages. These techniques allowed a web server to access enterprise data, usually through a database server, and to process the data before responding to a client's request.

Clearly, there is some functional overlap between clients, web servers, application servers, and database servers, with each component exhibiting unique advantages. In particular, ubiquitous web browsers such as MOZILLA, NETSCAPE, and INTERNET EXPLORER provide inexpensive (if not free), cross-platform user interfaces that comply (usually) with standard formats (e.g. HTML) and protocols (e.g. HTTP). Similarly, web servers generally offer a cross-platform, standard-compliant means of communicating with the browsers; application servers provide cross-platform access to customized business logic; and database servers provide cross-platform access to enterprise data. Today, an EIS generally integrates each of these components, thus capturing the best of all worlds and providing an architecture for implementing distributed, cross-platform enterprise applications.

Although the modern EIS provides an architecture for implementing distributed, cross-platform enterprise applications, historically, each EIS component has not been portable to other platforms (i.e. platform independent). In 1995, however, Sun Microsystems, Inc. (“SUN”) introduced a new product, “JAVA,” that provided the foundation for building such portable components. As introduced in 1995, JAVA comprised an object-oriented programming language and a processing architecture (the “JAVA virtual machine” or “JVM”). See David Flanagan, Java in a Nutshell 3 (3d ed. 1999). SUN touted JAVA as the only “write once, run anywhere” development tool, meaning that a developer could create a JAVA application and run it on any platform. More accurately, though, JAVA allows a developer to create a JAVA application and run it on any platform having a JVM. Several years later, SUN released a new JAVA specification, which included new language features and a new library of JAVA classes (the “JAVA platform”) designed to support stand-alone application development. See James McGovern et al., Java 2 Enterprise Edition 1.4 Bible 5 (Wiley Publishing, Inc. 2003). SUN marketed this specification as JAVA 2 Standard Edition (J2SE). Finally, in 1998, SUN released JAVA 2 Enterprise Edition (J2EE), which addressed the need for developing and deploying portable enterprise applications. Id. J2EE defines a standard multi-tier architecture for an EIS. Id. J2EE comprises a specification that defines the logical application components within an EIS, and defines the roles played in the development process. All J2EE components run within a “container” program, which the J2EE specification also defines. The components of a J2EE platform include application clients, applets, web components, and server components.

A JAVA “servlet” is a type of J2EE web component that can perform the application processing assigned to a middle tier, act as a proxy for a client, and even augment the features of the middle tier by adding support for new protocols or other features. See generally MageLang Inst., The Java Servlet API, at http://iava.sun.com/developer/onlineTraining/Servlets/Fundamentals/servlets. html. A servlet also can extend a web or application server's functionality and support dynamic generation of HTML documents. In this respect, a JAVA servlet is similar to native web server extension technologies such as Microsoft's ISAPI and ASP and Netscape's NSAPI. See, e.g., Clifford J. Berg, Advanced Java 2 Development for Enterprise Applications 604 (2d ed. 1999).

Like all J2EE components, a servlet runs within a container (sometimes also referred to as a servlet “engine”), which manages the servlet. The container loads and initializes the servlet, passes requests to the servlet and responses to a client, manages multiple instances of a servlet, and acts as a request dispatcher. The container also is responsible for destroying and unloading the servlet. For example, if the servlet's resources are needed elsewhere, the container destroys and unloads the servlet and then subsequently reloads and reinitializes the servlet if it is requested again. A servlet also is destroyed at the end of its useful life, and when the container shuts down. See Jeanne Murray, Building Java HTTP Servlets (September 2000), at https://www6.software.ibm.com/developerworks/education/j-servlets/j-servl-ets-ltr.-pdf. A container passes initialization information to a newly created servlet through a servletconfig object. See, e.g., MageLang Inst., supra. While running, a servlet can get information about its environment (or “context”) through a ServletContext object.

In practice, a client sends a request to a server, which specifies a servlet's URI. The server, or more likely, a container running within the server, then creates an instance (“instantiates”) of the servlet identified by the URI. The server or container also creates a thread for the servlet process. The servlet instance then stays active until the container explicitly destroys the servlet or the server shuts down. The container sends the request to the servlet, which processes the request and builds a response. The servlet constructs a response using information in the client request, and, if necessary, data from other EIS components. If the request uses HTTP, the servlet wraps the response in HTML. Finally, the servlet passes the response back to the client, through the container.

Naturally, SUN provides a JAVA Servlet Application Programming Interface (API), which defines a standard interface between a client, container, and servlet. See, e.g., id. The JAVA Servlet API includes two packages, one that supports generic protocol-independent servlets (the “javax.servlet” package), and one that provides specific support for HTTP (the “javax.servlet.http” package). Thus, a generic servlet must implement the javax.servlet.Servlet interface. Such generic servlets typically implement this interface by extending the javax.servlet.GenericServlet class, which is implemented in the javax.servlet package. A servlet that needs HTTP support (a “web servlet”), on the other hand, should extend the javax.servlet.http.HttpServlet class, which is implemented in the javax.servlet.http package. Almost all servlets written today are designed to use the HTTP protocol, so most servlets currently extend the javax.servlet.http.HttpServlet class. See Mark Andrews, Story of a Servlet: An Instant Tutorial, at http://iava.sun.com/products/servlet/articles/tutorial/.

The Servlet API generally provides support in four categories: (1) servlet life cycle management; (2) access to servlet context; (3) utility classes; and (4) HTTP-specific support classes. See, e.g., MageLang Inst., supra. A servlet and container communicate through the API methods, which include init(ServletConfig), and service(ServletRequest, ServletResponse).

As noted above, a container instantiates and initializes a servlet the first time it is needed. To initialize the servlet, the container invokes the servlet's init( ) method, passing a ServletConfig object as an argument. The ServletConfig object includes a getServletContext( ) method that returns a ServletContext object, which represents the server's environment. Generally, the init( ) method opens database or other server connections required to service a request. See, e.g., Murray, supra.

The service( ) method is the “heart” of the servlet. MageLang Inst., supra. A container invokes the service (ServletRequest, ServletResponse) method whenever a request invokes the servlet. Thus, each request message from a client results in a single call to the servlet's service( ) method. The service( ) method reads the request and produces the response message from its two parameters: a ServletRequest object, and a ServletResponse object. A ServletRequest object consists of name/value pairs of parameters and an InputStream. A ServletResponse object represents the servlet's reply back to the client.

The Java Servlet API is a standard supported by many web servers, especially those that are bundled with application servers. Berg, supra, at 604. Thus, the Servlet API provides a very convenient and secure framework for creating distributed applications that can serve dynamically generated HTML, and also can access other network servers, such as databases and application servers. To implement a distributed application with Java servlets, a web server must run a servlet container or an application server that has a servlet container capable of supporting the life cycle of servlets. McGovern et al., supra, at 78. A servlet container running within a web server is referred to generally as a “web container.” Likewise, a distributed application that relies on web servlets is referred to generally as a “web application.” Because web servlets plug into an existing server, they leverage a lot of existing code and technology. The server handles the network connections, protocol negotiation, class loading, and more. MageLang Inst., supra.

A JavaServer Page (JSP) is another type of J2EE web component that supports dynamic HTML generation. See, e.g., McGovern et al., supra, at 113. A JSP, in form, is similar to a static HTML document that contains embedded Java code. Functionally, though, a JSP is nothing but a servlet that a container automatically generates from a file containing valid HTML and JSP tags. The container interprets the JAVA code and incorporates any output that the code generates into the HTML content before returning the content to a client. Berg, supra, at 631. In practice, most JSP implementations compile portions of a JSP page into one or more runtime objects that can be cached for improved efficiency.

Servlets have become an important adjunct to application servers by providing a web-traversable gateway. Many products extend application server features including security, transaction management, and load balancing to the servlet container, thereby allowing servlets to become the universal gateway to these services. Berg, supra, at 607. A “gateway” servlet, found in application servers such as Tomcat and JBoss, handle specific Uniform Resource Locator (URL) patterns and route requests for those URLs to their final destination (typically a client) after reading configuration information and initializing the target.

A gateway servlet, though, like all J2EE components, must run within a container. The container loads and initializes the servlet, passes requests to the servlet and responses to a client, manages multiple instances of a servlet, and acts as a request dispatcher. The container also destroys the servlet at the end of its useful life. Servlets are unloaded and removed from memory when the container shuts down. Consequently, the container may remove a gateway servlet at any time, which may decrease application performance and/or impose additional requirements in container design. Gateway servlets also must undergo the lifecycle of a servlet, which may adversely affect application performance as well. Moreover, the gateway servlet concept does not provide a convenient means for implementing a downstream container that can leverage any of the host container's optimizations. The problem results from the predetermined nature of the servlets. The servlets function in a linear manner such that the result is predetermined. Therefore, if a request is made that does not conform to the known parameters and known functionality, the system is incapable of functioning.

More specifically, the above-described gateway servlets fulfill their respective, particular objectives and requirements, the aforementioned prior art does not describe an extensible URI-pattern-based servlet request-processing framework that allows processing and responding to requests for resources sent over a network by client programs to application programs in an EIS. The prior art makes no provision for providing functionality without being subjected to the constraints of traditional servlet design. Thus, there is a need in the art for an improved means of processing requests that overcomes the disadvantages of the current gateway servlet technology but still allows a developer to extend and customize a web application's functionality.

It would thus be beneficial to develop methods for creating web pages or creating any application whereby data is processed, retrieved, stored and subsequently displayed. There is also a need for a system that increases robustness and efficiency over traditional systems of development and deployment.

### SUMMARY OF THE INVENTION

According to the present invention, there is provided a system for processing a request, the system includes a request initiator for creating a request, a request receiver for receiving the request from the request initiator, wherein the request receiver is in communication with the request initiator, and data structuring device for sequencially structuring data for use in processing the request and providing a response to the request. A method of processing a request by creating a request, forwarding the request to a request processing system, receiving the request, processing the request, processing the output of the request, and providing a response to the request.

### BRIEF DESCRIPTION OF THE DRAWINGS

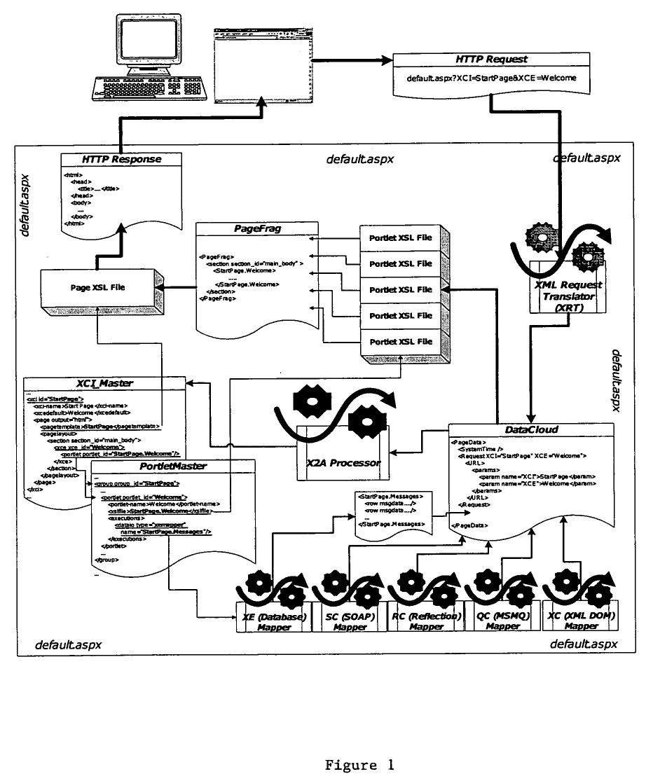

Other advantages of the present invention are readily appreciated as the same becomes better understood by reference to the following detailed description, when considered in connection with the accompanying drawing wherein FIG. 1 is a flow chart depicting the system of the present invention.

### DETAILED DESCRIPTION OF THE INVENTION

Generally, the present invention provides an application platform that enables fluid, sequential processing of information. Since the platform executes the program in a sequential not linear manner, unlike those of the prior art, the information or data that can be inserted into the platform is limitless. The information or data is limitless because the platform executes programs as necessary and as determined during execution, such that the result is not predetermined.

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The present invention is described best, though, as an extensible framework for deploying and using network resources in an EIS. In general, the framework comprises an improved container program and at least one “extension processor factory” program, which furnishes an “extension processor” program to process a client's request for a network resource. An extension processor factory is typically a third-party component that is registered with the web container. When an application is installed in the web container, the application queries the extension processor factory for a list of URI patterns that its extension processors will be responsible for handling.

The term “software” as used herein is intended to include, but is not limited to, a computer run device for performing the function defined herein. The software included herewith is written in a specific language; however, any computer language can be used. For example, the software can be written in C#, C++, SQL, Java, and other languages known to those of skill in the art that are able to function in the manner described herein. The software can be installed on individual computers, on a network of computers, or available via large scale networking system such as an Intranet, the Internet, or other similar communication device.

The software can also include security capabilities, thereby limiting who has access to the system. Examples of software security systems are well known to those of skill in the art. The security device is any method of preventing access to the method and software absent the inclusion of an access code. The access code can be any code that can be used to access the software. Examples of such access codes include, but are not limited to, a PIN, an access code, a password, and a URL with an identification number.

Preferably, the system of the present invention is a processing engine that processes structured requests as URLs and XML. The system of the present invention processes the requests according to a strict configuration utilizing XSLT and XML. This interpreted, but cached, system increases robustness and efficiency over traditional systems of development and deployment. The system of the present invention includes a 4GL style of checking and linking to data sources and interfaces so as to ensure proper application execution. Additionally, the system of the present invention monitors all timings and efficiency of execution during runtime. Finally, the system of the present invention inherently supports a loosely coupled environment that removes application component dependences.

Embodiments of the present invention include various steps, which are described in more detail in the examples. The steps can be embodied in machine-executable instructions. The instructions can be used to cause a general-purpose or special-purpose processor to perform certain steps. Alternatively, these steps can be performed by specific hardware components that contain hardwired logic for performing the steps, or by any combination of programmed computer components and custom hardware components.

Elements of the present invention can also be provided as a machine-readable medium for storing the machine-executable instructions. The machine-readable medium include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention can be downloaded as a computer program, which can be transferred from a remote computer (e.g., a server) to a requesting computer (e.g., a client) by way of data signals embodied in a carrier wave or other propagation medium via a communication link (e.g., a modem or network connection).

More specifically, the present invention provides a platform that, upon the insertion of a request, determines the programs to run and the order in which to run the programs in a sequential manner. The platform functions as follows: a request is made; the request is received by the application platform; the data is structured; and then the information is sent on. The most important step in the process is the data structuring. Prior art methods of structuring data are very linear. This means that the prior art platforms predetermine the programs to be run and the order that the programs are to be run, there is no alteration in the order or the programs utilized regardless of the request being made. This limits the requests that can be made for a platform, because if the platform is unprepared or incapable of structuring the data of a request, the no final result can be achieved. As stated previously, this creates the need for numerous different platforms for performing the necessary functions. In contradistinction, the present invention provides a platform that can structure data regardless of the request being made. Since the platform is fluid both in the programs that are run and the order in which the programs are run, there is created a platform that can provide virtually limitless results. The system of the present invention accomplishes this by first processing the request and then processing the output of the request. In order to process the request, the system enables the analysis and reconfiguration of the outcome because of a blending of code and data, such that there is no distinction between the code and data (known as a data cloud).

Specifically, the system functions as follows. When the client requests a page (default.aspx), there are two parameters on the URL: XCI (XML Class Interface) and XCE (XML Class Event), which indicate the page or portlet that the client desires (e.g. default.aspx?XCI=StartPage&XCE=Welcome). The XCI determines the Page that will be built and the XCE determines the “flavor” of that page. Note that those two parameters may not appear in the URL, when the engine uses default values instead. (See FIG. 1)

First, the ASP Request object is converted to an internal XML document called DataCloud. The system then examines two configuration files: XCI_Master.xml to see which portlets are required for the page in question, and PortletMaster.xml to get the definitions of those portlets. Each portlet can contain executions consisting of either dataios, which add external data to the DataCloud, or transforms, which analyze, and add their results back into the DataCloud. Once all executions have been performed, each portlet's XSL file is transformed against the entire DataCloud. These resulting page fragments are collected in a new XML document, referred to as the PageFrag. Once all portlets have been transformed, the PageFrag document itself is transformed against the PageTemplate, which is the XSL file specified for the requested XCI. The result of this transformation is what is sent to the client response as HTML.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLES

### Example 1

The example provides an in-depth look at the framework along with an exhaustive description of all the available settings.

Architecture Overview

Key Concepts
X2A2 (XMUXSLT Application Architecture) is an engine and development framework.
XML-based, so all configuration files, data and HTML are XML or XML-compliant.
Most of development is done by configuring files, rather than “coding.” There's virtually no ASP coding.
   Page Request Flow

A common page request is processed in the following order:
1. When the client requests a page (default.aspx), there are two parameters on the URL: XCI (XML Class Interface) and XCE (XML Class Event), which indicate the page or portlet that the client desires (e.g. default.aspx?XCI=StartPage&XCE=Welcome). The XCI determines the Page that will be built and the XCE determines the “flavor” of that page. Note that those two parameters may not appear in the URL, when the engine will use default values instead.
2. First the ASP Request object is converted to an internal XML document called DataCloud.
3. X2A2 then examines two configuration files: XCI_Master.xml to see which portlets are required for the page in question, and PortletMaster.xml to get the definitions of those portlets.
4. Each portlet may contain executions consisting of either dataios, which add external data to the DataCloud, or transforms, which analyze, and add their results back into the DataCloud.
5. Once all executions have been performed, each portlet's XSL file is transformed against the entire DataCloud. These resulting page fragments are collected in a new XML document, referred to as the PageFrag.
6. Once all portlets have been transformed, the PageFrag document itself is transformed against the PageTemplate, which is the XSL file specified for the requested XCI. The result of this transformation is what is sent to the client response as HTML.
   Configuration Files

Summary

| File Name | Description |
|---|---|
| Web.Config | Global Configuration File |
| XCI_Master.xml | Application settings, path information, |
| | page definition (XSL file and portlet list) |
| PortletMaster.xml | Portlet definition (XSL file and dataio list) |
| ECMapper.xml | Event Viewer Connector Mapper (post messages |
| | to Event Viewer) |
| QCMapper.xml | MSMQ |
| RCMapper.xml | Reflection: Call DLL's |
| SCMapper.xml | Soap Connector Mapper: interface to web services |
| XEMapper.xml | Database Mapper: database connections and |
| | stored procedure definition |

Note:
XCMapper is used in runtime to load an XML file in the DataCloud. There's no associated configuration file.

Web.Config

Some global application settings are placed under <appSettings> in Web.Config.

| Setting | Description |
|---|---|
| AppID | Application ID, matches @id attribute of |
| | <web-app> element in XCI_Master |
| PortletID | Application ID, matches @id attribute of |
| | <portlet-app> element in PortletMaster |
| RequestDumpFile | Location of dump files when in debug mode |
| DataCloudDumpFile | (SiteDebug is set to true or &debug = |
| PageFragDumpFile | secret passed on the URL). |
| CheckConnectionDumpFile | |
| ErrorMsgDumpFile | |
| LogQueue | MSMQ Log Queue |
| ErrorPage | Error Page |
| ErrorMessage | Control error message display mode: |
| | user/developer. |
| | Values: on (verbose), off |
| DebugPW | Site Debug settings: |
| SiteDebug | DebugPW defines password for “online” |
| | debugging (e.g. &debug = secret |
| | passed on the URL) |
| | SiteDebug = true turns debug on for the |
| | entire session so dump files are always |
| | generated. This option significantly |
| | reduces performance and should be |
| | false in production. Values: true |
| | or false. |

XCI_Master.xml

XCI_Master is the driving document for the application. It contains application settings, path information, and page definitions (XSL file used to generate page and the list of portlets used by each page).

```
<web-app-def>
    <web-app>
        <web-app-name>
        <connections>
            <portletmasterconnection>
            <group>
                <connection>
        <defaults>
            <xcidefault>
            <prepage>
                <portlet>
            <postpage>
                <portlet>
        <errors>
            <pagetemplate>
    <xci>
        <xci-name>
        <prepage>
            <xce>
                <portlet>
        <page>
            <pagetemplate>
            <pagelayout>
                <section>
                    <xce>
                        <portlet>
```

| Element | Description/Attributes |
|---|---|
| <web-app-def> | Document root |
| <web-app> | Web application definition (one XCI_Master may contain |
| | more than one <web-app>) |
| | @id: matches the AppID setting in web.config |
| <web-app-name> | Optional. Application description |
| <connections> | Contains <portletmasterconnection> and one or more |
| | connection <group> elements |
| | @loadstyle (currently always cached) |
| | cached: loaded during init, never refreshed |
| | immediate: loaded on every use |
| | timed: loaded during init, refreshed on first usage |
| | after “time” has passed |
| | @time: time in ms, when @loadstyle=timed |
| <portletmasterconnection> | XML file name, typically “PortletMaster.xml” |
| | @groupname, @loadstyle (see @loadstyle above) |
| <group> | Contains one or more <connection> elements |
| | @groupname |
| <connection> | Connection definition, typically XML or XSL file |
| | @name |
| <defaults> | Default settings |
| <xcidefault> | Default XCI to be displayed, when no XCI is in the URL |
| <prepage> | Contains portlets to be executed before the main page |
| <portlet> | @portlet_id |
| <postpage> | Contains portlets to be executed after the main page |
| <errors> | Error group |
| <pagetemplate> | Error page template |
| <xci> | @id |
| <xci-name> | Descriptive name |
| <prepage> | Contains portlets to be executed before the main page |
| <xce> | @xce_id: when xce_id=”*”, XCE is always displayed, |
| | regardless of the XCE argument passed on the URL |
| <page> | @output |
| | html: use when the page and portlets are displayed |
| | directly on the browser. |
| | xml: use when portlets are dynamically created in |
| | the application, which is usually the case for |
| | deferred portlets, and most ‘popup’ portlets. |
| <pagetemplate> | Page name that matches the <connection> @name |
| <pagelayout> | Defines page layout and contains one or more <section> |
| | elements |
| <section> | Divide the HTML output in sections. The final HTML will |
| | contain an XML element in the form <{section_id}> for each |
| | section. |
| | @section_id |

PortletMaster.xml

The PortletMaster contains the portlet definitions: XSL file used to generate the portlet and the list of dataios used by each portlet.

```
<portlet-app-def>
    <portlet-app>
        <portlet-app-name>
        <connections>
            <connectiongroup>
                <connection>
        <group>
            <portlet>
                <portlet-name>
                <portlet-description>
                <xslfile>
                <executions>
                    <transform>
                    <dataio>
                    <stop-if>
```

| Element | Description/Attributes |
|---|---|
| <portlet-app-def> | Document Root |
| <portlet-app> | Portlet application definition (one PortletMaster may contain |
| | more than one <portlet-app>) |
| | @id: matches the PortletID setting in web.config |
| <portlet-app-name> | Description (optional) |
| <connections> | Contains one or more <connectiongroup> elements |
| | @loadstyle (currently always cached) |
| | cached: loaded during init, never refreshed |
| | immediate: loaded on every use |
| | timed: loaded during init, refreshed on first usage |
| | after “time” has passed |
| | @time (when loadstyle=timed, time in ms) |
| <connectiongroup> | Parent element of one or more <connection> elements |
| | @groupname, @loadstyle (see @loadstyle above) |
| <connection> | Connection definition, typically an alias for the portlet XSL file |
| | @name |
| <group> | Parent element of one or more <portlet> elements |
| | @group_id, @description |
| <portlet> | Portlet definition. Portlets are referred by their |
| | “{group_id}.{portlet_id}” |
| | @portlet_id, @description, @href |
| <portlet-name> | Optional. Description |
| <portlet-description> | Optional. Long Description |
| <xslfile> | Matches <connection> @name |
| <executions> | Contains one or more ‘execution’ elements such as <dataio> |
| <transform> | Optional. Given the Datacloud XML, perform preliminary |
| | transformation before the final page transformation. |
| | @name: a new tag is appended to Datacloud |
| | @src: XSL file used to transform data. Can be overridden |
| | by adding a parameter: |
| | <param name=“connection” type=“xpath” |
| | source=“source”> |
| | @output: DataCloud |
| <dataio> | Executes a data method from one of the mappers |
| | @name: matches {group @name}.{mapper @name} |
| | @test: Optional. Xpath condition to execute dataio |
| | @type: mapper type (xemapper, scmapper, dyndataio, |
| | etc) |
| <stop-if> | Optional. Stop current execution and execute action defined |
| | by @method |
| | @name |
| | @method: redirect |
| | @test: xpath condition |
| | @type: xpath, literal |

ECMapper.xml

Event Viewer Connector Mapper, used to post messages to Event Viewer.

```
<ecmapper>
    <connections>
        <connection>
    <mappers>
        <group>
            <mapper>
                <description>
                <params>
                    <param>
```

| Element | Description/Attributes |
|---|---|
| <connections> | Contains one or more <connection> elements |
| <connection> | Connection definition |
| | @name |
| | @logname |
| | @description |
| <mappers> | Contains one or more <group> elements |
| <group> | Contains one or more <mapper> elements |
| | @name |
| | @description |
| <mapper> | Mapper definition |
| | @name |
| | @connection |
| | @action |
| | @description |
| <description> | Description (optional) |
| <params> | Contains one or more <param> elements |
| <param> | Parameter definition |
| | @name |
| | @type |
| | @description |
| | @operator |

QCMapper.xml

QCMapper controls access to Microsoft Message Queuing (MSMQ)

```
<qcmapper>
    <connections>
        <connection>
    <mappers>
        <group>
            <mapper>
                <description>
                <params>
                    <param>
```

| Element | Description/Attributes |
|---|---|
| <connections> | Contains one or more <connection> elements |
| <connection> | Connection definition |
| | @name |
| | @wait |
| | @description |
| <mappers> | Contains one or more <group> elements |
| <group> | Contains one or more <mapper> elements |
| | @name |
| | @description |
| <mapper> | Mapper definition |
| | @name |
| | @connection |
| | @action |
| | @description |
| <description> | Description (optional) |
| <params> | Contains one or more <param> elements |
| <param> | Parameter definition |
| | @name |
| | @type |
| | @format |
| | @description |

RCMapper.xml

Reflection mapper, used to Call DLL's.

```
<rcmapper>
    <connections>
        <connection>
    <mappers>
        <group>
            <mapper>
                <description>
                <params>
                    <param>
```

| Element | Description/Attributes |
|---|---|
| <connections> | Contains one or more <connection> elements |
| <connection> | Connection definition |
| | @name |
| | @description |
| <mappers> | Contains one or more <group> elements |
| <group> | Contains one or more <mapper> elements |
| | @name |
| | @description |
| <mapper> | Mapper definition |
| | @name |
| | @connection |
| | @type |
| | @method |
| | @description |
| <description> | Description (optional) |
| <params> | Contains one or more <param> elements |
| <param> | Parameter definition |
| | @name |
| | @datatype |
| | @type |
| | @format |
| | @description |

SCMapper.xml

Soap Connector Mapper: interface to web services.

```
<scmapper>
    <connections>
        <connection>
    <mappers>
        <group>
            <mapper>
                <description>
                <params>
                    <param>
```

| Element | Description/Attributes |
|---|---|
| <connections> | Contains one or more <connection> elements |
| <connection> | Connection definition |
| | @name |
| | @description |
| <mappers> | Contains one or more <group> elements |
| <group> | Contains one or more <mapper> elements |
| | @name |
| | @description |
| <mapper> | Mapper definition |
| | @name |
| | @connection |
| | @method |
| | @description |
| <description> | Description (optional) |
| <params> | Contains one or more <param> elements |
| <param> | Parameter definition |
| | @name |
| | @type |
| | @format: xml or text |
| | @description |

XEMapper.xml

The XE Mapper is the Database Mapper and is used for direct interaction with the database, usually via stored procedures. It contains information about database connections, stored procedures and their parameters.

```
<xemapper>
    <connections>
        <connection>
    <mappers>
        <group>
            <mapper>
                <params>
                    <param>
                <handlers>
```

| Element | Description/Attributes |
|---|---|
| <connections> | Contains one or more <connection> elements |
| <connection> | Database Connection definition |
| | @name: used by @name attribute of <mapper> |
| | element |
| | @description: complete connection definition |
| | Data Source=server ;Initial Catalog=database ;UID= |
| | user;Password=pwd; |
| <mappers> | Contains one or more <group> elements |
| <group> | Parent element of one or more <mapper> elements |
| | @name, @description |
| <mapper> | Mapper definition |
| | @name: mapper name as it will be referred by the \| |
| | <dataio> element. Naming convention: stored |
| | procedure name without the usp_prefix. |
| | @connection: matches @name attribute of |
| | <connection> element |
| | @procedure: stored procedure name |
| | @transaction (true\|false): when true, transaction |
| | statements (BEGIN TRANS, COMMIT TRANS) |
| | are added to the <dataio> execution |
| <params> | Contains one or more <param> elements |
| <param> | Parameter definition |
| | @name: parameter name as in the stored procedure |
| | @type: xpath, literal |
| | @source: always ‘source’ on XEMapper file (can also |
| | be ‘result’ when creating an XE connector instance |
| | outside of XEMapper) |
| <handlers> | Error handling for foreign key constraints. Reserved |
| | for HL7 interfaces, and usually not used for portlet |
| | development. |

System XML Documents

The X2A2 Framework defines some XML Documents that reside in memory and help gather data and build portlets and pages. When the site is in debug mode, a physical copy of the XML Documents is saved to folder \FrontEnd\CoreComponents\X2A2\dump. See section Website Settings on CPNG Developer Handbook for more details on setting site debug.

DataCloud

The DataCloud is where the data for every page request resides. Each page request is converted to a DataCloud object consisting of a root <PageData> element, and containing elements <SystemTime> and <Request>. In addition, any data obtained from portlet executions (dataio) is appended as children of <PageData> root.

```
<PageData>
    <SystemTime />
    <Request>
        <URL>
            <Element>
            <Params>
                <Param>
        <HTTPHeaders>
            <Header>
        <ServerVariables>
            <Variable>
    <{dataio Id}>
    <PortletData />
    <FinalPageData />
```

| Element | Description/Attributes |
|---|---|
| <PageData> | Main root element |
| | @ApplicationName, @Version, @Legal, |
| | @runtime_GatherPortlets |
| <SystemTime> | “True time” according to the web servers, which will always |
| | be synched with the database servers. |
| | @utc (Oct. 12, 2005 7:02:12 PM), @month (10), |
| | @monthName (October), @monthAbbrev (Oct), |
| | @day (12), @dayName (Wednesday), @year (2005), |
| | @hour24 (15), @hour12 (3), @minutes (02), |
| | @seconds (12), @ampm |
| <Request> | Useful bits of the IIS Request object |
| | @Method, @ContentType, @XCI, @XCE, @UserNo, |
| | @ClientIP, @runtime |
| <URL> | Parent element to one or more <Element> elements and |
| | <Params> element |
| | @url |
| <Element> | One element for each component of the URL: protocol, |
| | host, path, page |
| | @name |
| <Params> | Parent element to one or more <Param> elements |
| | @runtime |
| <Param> | One element for each parameter passed on the URL: |
| | protocol, host, path, page |
| | @name |
| <HTTPHeaders> | Parent element to one or more <Header> elements |
| | @runtime |
| <Header> | One element for HTTP Header such as Connection, Accept- |
| | Language, Host, etc. |
| | @name |
| <ServerVariables> | Parent element to one or more <Variable> elements |
| | @runtime |
| <Variable> | One element for each Server Variable such as |
| | @name |
| <dataio Id> | One element for each dataio e.g. |
| | “PtPage.InsurancesGetForEncounter” |
| | @status, @runtime, @data (true\|false) |
| <PortletData> | Information about each portlet execution |
| | @id, @TransformTime |
| <FinalPageData> | Information about the page execution |
| | @XCI, @TransformTime |

PageFrag

The PageFrag is created by running each portlet transformation against the DataCloud and appending the results sequentially into one XML document. This document becomes the source for the parent Page's final transformation, whose output is the final client payload.

```
<PageFrag>
    <{section_id}>
        <portlet>
        ...
        <portlet>
```

| Element | Description/Attributes |
|---|---|
| <PageFrag> | Main root element |
| | @Legal |
| <{section_id}> | Element named after the Section containing the portlet |
| | (@section_id of <section> element defined in |
| | XCI_Master) |
| | Contains one or more <portlet> elements |
| <portlet> | Complete portlet contents after transformation, |
| | possibly including a populated <portlet-Data> |
| | element. |
| | @id, @TransformTime |

Portlet Specification

```
  <portlet>
<title>
  <configuration>
<isMovable>
<canMinMax>
<canClose>
<canPrint>
<usesData>
<noControls>
          <buttons>
              <cellpadding>
              <additionalButtons>
                    <button>
  <portlet-placeholder>
  <portlet-CSS-JS>
  <portlet-UI>
<portlet-header />
<portlet-filters />
<portlet-body>
<portlet-footer>
  <portlet-Data>
  </portlet>
```

| Element | Description/Attributes |
|---|---|
| <portlet> | Portlet root element |
| | @id |
| | @showPlaceholder: Optional. Determine if only place |
| | holder section should be displayed. Values: yes, no |
| | (default) |
| | @mode: Optional. When mode=development, display |
| | link to portlet documentation. Values: development, |
| | production (default) |
| <title> | Portlet title bar (not to be confused with the HTML page |
| | <title>) |
| <configuration> | Root element that contains one or more configuration |
| | settings |
| <canMinMax> | Optional. Values: yes, no (default) |
| <canClose> | Optional. Values: yes, no (default) |
| <canPrint> | Optional. Values: yes, no |
| <usesData> | Optional. Determine if portlet uses client-side data. Values: |
| | yes, no (default). Coupled with the <portlet-Data> section |
| | below. |
| <noControls> | Optional. When yes, no buttons are displayed. Values: |
| | yes, no (default) |
| <buttons> | Element that controls buttons display. |
| <cellpadding> | cellpadding for portlet buttons |
| <additionalButtons> | Contains one or more <button> elements, in addition to |
| | standard ones defined by settings like print, min, max, |
| | close, etc |
| <button> | Extra button element to be displayed. |
| | @btn_name: button name |
| | @btn_click: javascript |
| | @img_base_name: button image “root”. Actual image |
| | files must have the format <base_name><suffix>, |
| | where suffix can be: |
| | -N.gif, -S.gif, -D.gif |
| | @width, @height: size attributes in pixels |
| | @btn_display: Text to be displayed above button |
| | @btn_desc: tooltip help |
| <portlet-placeholder> | Content to be temporarily displayed as the portlet body, |
| | typically used when defining the page layout before the |
| | portlet is fully developed. |
| <portlet-CSS-JS> | Root element for any javascript code or stylesheets |
| <portlet-UI> | Root for the other UI elements (header, body, footer, etc) |
| <portlet-header> * | Header configuration, no content (*) |
| <portlet-filters> * | Filter “bar” configuration and content. Filters such as date |
| | range placed here will appear under the portlet header (*) |
| <portlet-body> * | Body configuration and content. Main portlet content |
| | placed here. (*) |
| <portlet-footer> * | Footer configuration and content, typically submit buttons |
| | like Save. (*) |
| * Common Attributes | @useDivWrapper (yes or no) |
| (used by <portlet- [symbol] | @style: custom CSS style |
| <portlet-filters>, <portl [symbol] | @class: CSS class |
| <portlet-footer>) | @onkeypress, @onmouseover, @onmouseout, |
| | @onclick: javascript events |
| | @divider-line: Values: yes, no (default) |
| <portlet-Data> | If the portlet uses client-side data (<usesData>=yes in |
| | <configuration>), then this section specifies what that |
| | data will be. Typically this is an <xsl:copy-of> one or more |
| | elements in the DataCloud. When the client-side portlet |
| | loads, it will load the contents of the portlet-Data element |
| | as an XML document with the portlet-Data element as the |
| | root. |

Quizlet Specification

| | <Quizlet> |
|---|---|
| | <DataBlockLink/> |
| | <Executions> |
| | <dataio/> |
| | <OrdersInfo> |
| | <Order> |
| | <{Custom Tags}> |
| | <Group> |
| | <Question> |
| | <Text/> |
| | <Answer> |
| | <Value/> |
| Element | Description/Attributes |
| <Quizlet> | Quizlet root element |
| | @name: |
| | @layout: label_side |
| <DataBlockLink> | Placeholder tag used by the architecture to add |
| | information about the user, patient and order during |
| | quizlet processing. Usually not modified by |
| | developers, so always coded as <DataBlockLink/> |
| <Executions> | Contains one or more ‘execution’ elements such as |
| | <dataio> |
| <dataio> | Executes a data method from one of the mappers |
| | @name: matches |
| | {group @name}.{mapper @name} |
| | @test: Optional. Xpath condition to |
| | execute dataio |
| | @type: mapper type (xemapper, scmapper, |
| | dyndataio, etc) |
| <OrdersInfo> | Contains one or more <Order> elements |
| <Order> | Order to be processed. Maps to a template in |
| | ProcessOrders.xsl. |
| | @id: |
| | @type: |
| | @process: true or false |
| <{Custom Tags}> | Used by ExpandOrders.xsl to copy information from |
| | <Question> elements to <Order> element |
| | and also to add hard-coded information. |
| | @type: xpath (value-of) or xpathdeep (copy-of) |
| <Group> | Contains one or more <Question> elements |
| | @id: |
| | @groupname: |
| | @display: true or false |
| <Question> | Question element |
| | @name: |
| | @orderid: |
| | @required: true or false |
| | @touched: true or false |
| | @move: true or false |
| | @layout: label_side, label_top |
| | @report: true or false |
| | @reportname: |
| | @displaygroup: |
| | @divider: true or false |
| | @disabled: true of false |
| <Text> | Question Label |
| <Answer> | HTML Control |
| | @type: allergy_widget, text_field, text_area |
| <Value> | Field value to be displayed (default value or |
| | existing record) |

XSL Libraries
CommonFunctions.xsl

Located under \FrontEnd\CPNGWebsite\includes

| Template Name | Parameters | Output |
|---|---|---|
| RipRoot | RootNode | |
| HTMLEncodeNode | ContentNode, id | Well-formed Node (handling of |
| | | special characters) |
| HTMLEncodeText | Text | Well-formed Text (handling of |
| | | special characters) |
| StringReplace | string, search, | |
| | replace | |

PageFunctions.xsl

Located under \FrontEnd\CPNGWebsite\includes

Includes CommonFunctions.xsl and any page-specific templates

PortletFunctions.xsl

Located under \FrontEnd\CPNGWebsite\includes

Includes CommonFunctions.xsl and any portlet-specific templates

XSL Templates

| Template Name | Parameters | Output |
|---|---|---|
| StandardFullAddress | Address1, Address2, City, | 999 Main St. |
| | State, Zip, Country | Apt 99 |
| | | City, XX 99999 |
| | | USA |
| StandardFullName | Prefix, GivenName, | Mr. Smith, John Doe Jr MD. |
| | MiddleName, FamilyName, | or |
| | Suffix, Prefix | Mr. John Doe ˜Smith Jr MD. |
| | StartWith: GivenName or | |
| | FamilyName (default) | |
| StandardGreeting | SystemTime, Prefix, | Greeting: |
| | GivenName, MiddleName, | Good (Morning, Afternoon, |
| | FamilyName, Suffix | Evening) |
| | | Mr. John Doe Smith Jr. |
| StandardDate | Date | mm/dd/yyyy (internally uses |
| | (2003-07-24T09:46:31.393) | ms: format-date, and it will make |
| | | it easy to modify format later if |
| | | necessary) |
| StandardAge | Date | Age |
| | (2003-07-24T09:46:31.393) | |
| StandardDateAge | Date | mm/dd/yyyy (Age) |
| | (2003-07-24T09:46:31.393) | |
| StandardDateTime24 | Date | mm/dd/yy HH:mm (time 24) |
| | (2004-10-03T16:53:55.040) | Oct. 03, 2004 16:53 |
| StandardDateTime12 | Date | mm/dd/yy hh:mm (AM/PM) |
| | (2004-10-03T16:53:55.040) | (time 12) |
| | | Oct. 03, 2004 04:53 PM |
| PatientLocation | NursingStation, Room, Bed | NS/Rm-Bed |
| | | ONC/3116-02 |
| GetBaseURL | | Rebuilt base URL from Datacloud |
| | | <URL> element |
| BreadCrumbs | contents, id, skinPath | Navigation Bread crumbs |
| | | displayed on |
| | | main header |
| PatientTabs | | Patient Tabs |
| TransparentSeparator | | |

DeferredPortlet.xsl

Located under \FrontEnd\CPNGWebsite\includes

Parameters

| | |
|---|---|
| Parameter Name | Description |

Portlet
PaneName
URLParams

QuickNode.xsl

Located under \FrontEnd\CPNGWebsite\includes

Parameters

| Parameter Name | Description |
|---|---|
| source | Mandatory. DataCloud XML element used to build table. Default = no. |
| id | Mandatory. Table id attribute is used to generate ids for all internal |
| | elements of QuickTable. Default = quicknode. |
| title | Optional. Override to specify table title. Default = ‘’. |
| orientation | Optional. use this to force the layout (portrait\|landscape), otherwise |
| | it will be determined by the source data. Default = ‘’. |
| class | Optional. CSS class for the body table and all child elements. |
| | Default = contentBody. |
| classhighlight | Optional. Alternating CSS class for odd lines. Default = content |
| | OddOrHoverLine. |
| tablestyle | Optional. override to set the overall style of the. Default = ‘’. |
| tablewidth | Optional. Table width attribute. Default = ‘’. |
| cellpadding | Optional. cellpadding to be set for outside table. Default = 0 |
| cellspacing | Optional. cellspacing to be set for outside table. Default = 0 |
| canclose | Optional. Determine if the table can open and close. Values: |
| | yes(default), no |
| showtitle | Optional. Determine if the table header is displayed. Values: yes |
| | (default), no |
| showcolheaders | Optional. Determine if columns headers are displayed. Values: yes |
| | (default), no |
| captionprefix | Optional. Those 2 parameters allow to surround name of node |
| captionsuffix | with prefix and suffix strings. Expample: column after name of the |
| | value. Default = ‘’ |
| onmouseover | Optional. Action triggered by row event. For onmouseover and |
| onmouseout | onmouseout events if highlighting is necessary then in addition to |
| onclick | specified action they are going to be performed. |
| ondblclick | |
| iconExpand | Optional. Plus icon that is used to show body of table (default = images/iconExpand.gif). |
| iconCollapse | Optional. Plus icon that is used to show body of table (default = images/iconExpand.gif). |
| usetemplates | Optional. Match templates instead of auto-generating rows. |
| | Values: yes, no (default) |

Example from . . . Portlets/PtPage/Summary_Demographics.xsl:

```
<xsl:call-template name=“QuickNode”>
    <!-- set source parameter of QuckNode by accessing xml node-set
in the variable above -->
    <xsl:with-param name=“source” select=“msxsl:node-
set($patientDemographics)/pdRow”/>
      <xsl:with-param name=“class”>ContentBody</xsl:with-param>
      <xsl:with-param name=“orientation”>portrait</xsl:with-param>
      <xsl:with-param name=“showtitle”>no</xsl:with-param>
      <xsl:with-param name=“captionsuffix”>:</xsl:with-param>
</xsl:call-template>
```

QuickGrid.xsl

Located under \FrontEnd\CPNGWebsite\includes

Parameters

| | |
|---|---|
| Parameter Name | Description |

Portlet
PaneName
URLParams

QuickMenu Template

Located under \FrontEnd\CPNGWebsite\includes

| Parameter Name | Description |
|---|---|
| id | Mandatory. Allows id generation for all the elements that |
| | are |
| | created within menu. |
| Contents | Mandatory. XML representation of menu. See below for |
| | the |
| | details of XML structure. |
| onblur | Optional. Executed on onblur event of the menu item. |
| MenuTdLeftRowspan | Optional. CSS class that defines appearance of left |
| | padding |
| | of menu. |
| MenuTdRightRowspan | Optional. CSS class that defines appearance of right |
| | padding |
| | of menu. |
| MenuSpan | Optional. CSS class that defines appearance of textual |
| | part of |
| | menu item. For highlight define CSS class with same |
| | name |
| | and Selected in the end. |
| MenuTdPosition1NextSep | Optional. Menu Item on top of menu and followed by |
| | separator. |
| MenuTdPosition1 | Optional. Menu Item on top of menu and not followed by |
| | separator. |
| MenuTdPositionLastPrevSep | Optional. Menu Item on bottom of menu and preceded by |
| | separator. |
| MenuTdPositionLast | Optional. Menu Item on bottom of menu and not preceded |
| | by |
| | separator. |
| MenuTdNextSepPrevSep | Optional. Menu item that is not first or last and preceded |
| | with |
| | separator and followed with separator. |
| MenuTdNextSep | Optional. Menu item that is not first or last and not |
| | preceded |
| | with separator and followed with separator. Optional. |
| MenuTdPrevSep | Optional. Menu item that is not first or last and preceded |
| | with |
| | separator and not followed with separator. Optional. |
| MenuTd | Optional. Menu item that is not first and not last and not |
| | preceded with separator and not followed with separator. |
| | Optional. |

All parameters except id and Contents are almost never to be changed.

Contents Parameter

<menu>
<item/>

| Element | Description/Attributes |
|---|---|
| <menu> | Contains one or more <item> elements |
| <item> | Menu item |
| | @id: Required. Used to add to id of menu to generate id of |
| | menu item. |
| | @label: Required. Used as text to display on menu |
| | @type: Required. Values script, link, action, ‘separator’ |
| | @script: Relevant only if type attribute is set to ‘script’. |
| | Defines script to be executed on menu click. |
| | @link: Relevant only if type attribute is set to ‘link’. |
| | Defines link to URL to go when menu item is clicked |
| | @action: Relevant only if type attribute is set to ‘action’. |
| | Defines action to take when menu item is clicked. |
| | @default: Values yes, no. If set to yes menu item is |
| | shown bold. And for portlet or QuickTable, or for patient |
| | header javascript of this item acts like double click action. |

QuickTable.xsl

Located under \FrontEnd\CPNGWebsite\includes

This XSL template builds a simple table using the XML element defined by the ‘source’ parameter. Rows are created from the first level of children from source element, and columns from attributes of those children.

Frequently Used Parameters

| Parameter Name | Description |
|---|---|
| source | Mandatory. DataCloud XML element used to build table. Default = no. |
| id | Mandatory. Table id attribute is used to generate ids for all |
| | internal elements of QuickTable. Default = no. |
| canClose | Optional. Determine if the table can open and close. Values: |
| | yes(default), no |
| isClosed | Optional. Determine if the table is initially closed. Default = no |
| showMenu | Optional. Determine if menu is present. Default = no |
| menuContents | Optional. XML that is defining content for drop down menu on |
| | the header. Default = no See description of XML below. |
| columns | Optional. If this parameter is equal to no then template will use |
| | list of attributes in source XML to build list of columns in the table. |
| | Otherwise columns XML is going to control columns present and |
| | their behavior. Default = no. See description of XML structure of |
| | columns below. |
| emptyListText | Optional. This string is to be shown when there is no rows in |
| | DataCloud in source element. Default = “List is empty”. |
| showTitle | Optional. Determine if the table header is displayed. Values: |
| | yes (default), no |
| title | Optional. Override to specify table title. Default = ‘’. |
| showColHeaders | Optional. Determine if columns headers are displyed. Values: |
| | yes (default), no |
| usetemplates | Optional. Match templates instead of auto-generating rows. |
| | Values: yes, no (default) |
| copysourcexml | Optional. Drop a copy of the source XML into a data area. |
| | Values: yes, no (default) |
| showIndicators | Optional. Determine usage of indicators. Values yes, no(default) |
| indicators | Optional. Specifies images that are used for certain columns |
| | instead of displaying actual textual value. Default = no; See |
| | description below. |
| filterthreshold | Optional. Usage is not documented. Default = 0. |

Infrequently Used Parameters

This family of QuickTable parameters must almost never change.

| Parameter Name | Description |
|---|---|
| class | Optional. CSS class for the body table and all child |
| | elements. Default = contentBody. |
| classOdd | Optional. Alternating CSS class for odd lines. Default = content |
| | OddOrHoverLine. |
| classHighlight | Optional. CSS class for auto highlighting row onmouseover. |
| | Default = contentOddOrHoverLine. |
| tableClass | Optional. CSS class for external table that controls layout of |
| | table header and body. Default = Content |
| | OutsideCompartment |
| tableWidth | Optional. Table width attribute. Default = ‘’. |
| cellpadding | Optional. cellpadding to be set for outside table. Default = 0 |
| cellspacing | Optional. cellspacing to be set for outside table. Default = 0 |
| classHeaderTdLeft | Optional. CSS class for the left td for header of the table. |
| | Default = contentOutsideHeaderLeftTd |
| classHeaderTdRight | Optional. CSS class for the right td for header of the table. |
| | Default = contentOutsideHeaderRightTd |
| onMenuOpen | Optional. Java Script to fired on onclick event for the menu |
| | indicating image before opening actual menu. Default = ‘’. |
| showChildren | Optional. Determine if children elements displayed. Values: |
| | yes, no (default) |
| hide1stcol | Optional. Determine if first column is hidden (e.g. primary |
| | key). Values: yes, no (default) |
| rowsperpage | Optional. Limit number of rows per page and display paging |
| | buttons. Default = 6. If set to 0 then it indicates that paging |
| | will not be there and all rows of the table will be visible. |
| initialPage | Optional. Number of initially displayed page. By default 1. If |
| | rowsperpage is 0 then ignored. |
| classPageNav | Optional. Use this parameters to set classes for images that |
| classPageNavMouseOver | represent navigation through pages. |
| classExpand | Use this parameter for class the images that can be clicked |
| | and need cursor hand. Default = content |
| | OutsideFramedImage. |
| onmouseover | Optional. Action triggered by row event. For onmouseover |
| onmouseout | and onmouseout events if highlighting is necessary then in |
| onclick | addition to specified action they are going to be performed. |
| oncontextmenu | |
| iconExpand | Optional. Plus icon that is used to show body of table |
| | (default = PlusHeader.gif). |
| iconCollapse | Optional. Plus icon that is used to show body of table |
| | (default = MinusHeader.gif). |
| iconExpandContent | Optional. Plus icon that is used to show internal table. |
| | Default = PlusContent.gif. |
| iconCollapseContent | Optional. Minus icon that is used to show internal table. |
| | Default = MinusContent.gif. |
| iconFirst | Optional. Images represent page navigation. Defaults are, |
| iconPrev | respectively, GoBegin.gif, GoPrevious.gif, GoNext.gif, |
| iconNext | GoEnd.gif, GoBeginDisabled.gif, GoPreviousDisabled.gif, |
| iconLast | GoNextDisabled.gif, GoEndDisabled.gif. |
| iconFirstDisabled | |
| iconPrevDisabled | |
| iconNextDisabled | |
| iconLastDisabled | |
| iconOpenMenu | Optional. These image represents areas to be clicked when |
| | want to open drop down menu. Default value = OpenMenuContent.gif. |
| iconSortUp | Optional. Image represents descending order. Default = SortUp.gif |
| iconSortDown | Optional. Image represents ascending order. Default = SortDown.gif |
| CustomContent | Optional. This parameter is used if body of the table is |
| | different then default generation routine but still header of the |
| | QuickTable must be generated. Default = no |
| isInternal | Optional. shows whether or not table is internal to other |
| | table. If yes certain styling is altered to feet best inside of the |
| | table. Default = no |
| showTransparentSeparator | Optional. Set this parameter to yes to have padding |
| | between QuickTables. Values yes(default), no |
| footerContents | Optional. html content that is to occupy footer area of |
| | QuickTable. Default = no |

Columns Parameter

If this parameter is equal to no then it will use list of attributes in source XML to build list of columns in the table. Otherwise columns XML is going to control columns present and their behavior.

```
<columns>
    <column>
    <columns>
        <footerContents>
        <column>
        <columns>...
```

| Element | Description/Attributes |
|---|---|
| <columns> | Acts as root element and can be included in itself recursively to represent |
| | expanded tables. |
| | On root level can have only key attribute and can have only |
| | column and columns child elements. |
| | @key: |
| | Name of Database field that is used to generate sourceId |
| | attribute for the row and name or <tr> for expanded table. |
| | On consequent levels can also have footerContents child |
| | element and have following attributes: |
| | @ onExpandChildren: |
| | Serves as onExpandChildren parameter for recursive level of |
| | expanded table. |
| | @ emptyListText: |
| | Serves as emptyListText parameter for recursive level of |
| | expanded table. |
| <column> | Attributes: |
| | @id: Mandatory. addition to id parameter of QuickTable |
| | that will be added id of header <th> of column via ‘_’ |
| | separator. |
| | @name: Optional. Title of the column. If not present name |
| | of the field will be split on ‘_’ symbols and used as title. |
| | @field: Mandatory. name of attribute in row element that |
| | will be used for this column as source of information. |
| | @sortable:. Optional. Whether or not this column can be |
| | sorted. Values yes, no(default). |
| | @sortType: Optional. Meaningful only when sortable is set |
| | to yes If table is not sorted by this column then it is no. |
| | asc and desc specify direction of sorting. Values asc, desc |
| | and no. |
| | @onclick: Optional. specifies onclick event for <td> |
| | @oncontextmenu: Optional. specifies oncontextmenu |
| | event for <td>. |
| | @ondblclick: Optional. specifies ondblclick event for <td>. |
| | @type: Optional. Values ‘Date’, ‘Age’ and ‘indicator’ For |
| | ‘Date’ value StandardDate template is called. For ‘Age’ |
| | value StandardAge template is called. For ‘indicator’ value |
| | QuickTable template is going to search indicators XML |
| | parameter for element with the same field and the same |
| | value for image to use. |
| | @length: Optional. How many symbols maximum are to |
| | be displayed. |
| | @titleType: Optional. If literal then tool tip will display |
| | exactly what is specified by title element. If field then value |
| | of database field of name specified in title attribute will be |
| | used. Values ‘literal’, ‘field’. |
| | @title:. Optional. Sets ‘title’ attribute for <td> that sets |
| | tool tip for td. Used to specify either sentence to display |
| | when titleType is ‘literal’ or value of specified field if |
| | titleType is ‘field’. When specify must specify titleType and |
| | vise versa. |
| | @useTemplates: Optional. If yes then apply-templates will |
| | be called when process this columns <td> elements. Then |
| | custom templates must be specified for columns with |
| | alternative look and feel. See implementation of FlashList |
| | portlet. Values yes, no(default). |

Indicators Parameter

If shown Indicators parameter is equal to no then it will be ignored. If columns parameter is equal to no then will be ignored. If column type attribute is equal to ‘indicator’ then indicators XML will be searched for <indicator> element with attribute field that correspond to attribute field of the <column>

<indicators>
<indicator/>

| Element | Description/Attributes |
|---|---|
| <indicators> | Acts as root element. Has no attributes. Required. Can have |
| | from 0 to ∞ <indicator> child elements. |
| <indicator> | Attributes: |
| | @value: Mandatory. Value that field shall take to |
| | display this image. |
| | @field: Mandatory. Field which value will be |
| | compared with value parameter. |
| | @image: Mandatory. Image to display. |
| | @imageHeader: Optional. If image in header area |
| | must be different then in content then specify. |
| | @desc: Optional. Description to show when mouse is |
| | over. |

menuContents Parameter

If showMenu parameter is equal to no then content of menuContents parameter will be ignored. XML of this parameter has following structure:

```
<menuContents>
    <menu>
        <item>
```

| Element | Description/Attributes |
|---|---|
| <menuContents> | Mandatory. Acts as root element. Has no attributes. Can |
| | have and must have <menu> element. |
| <menu> | No attributes |
| | Can have as many and necessary <item> elements |
| <item> | Attributes: |
| | @id: Required. Used to add to id of menu to generate id of |
| | menu item. |
| | @label: Required. Used as text to display on menu |
| | @type: Required. Values ‘script’, ‘link’, ‘action’, ‘separator’ |
| | @script: Optional.Relevant only if type attribute is set to |
| | ‘script’. Defines script to be executed on menu click. |
| | @link: Optional. Relevant only if type attribute is set to |
| | ‘link’. Defines link to URL to go when menu item is clicked |
| | @action: Optional.Relevant only if type attribute is set to |
| | ‘action’. Defines predefault action to take when menu item |
| | is clicked. |
| | @default: Optional. Values yes, no. If set to yes menu |
| | item is shown bold. And for portlet or quick table or for |
| | patient header javascript of this item acts like double click action. |

### EXAMPLE

```
<xsl:call-template name=“QuickTable”>
    <xsl:with-param name=“copySourceXML”>no</xsl:with-param>
    <xsl:with-param name=“canClose”>yes</xsl:with-param>
    <xsl:with-param name=“emptyListText”>No flashlist links</xsl:with-param>
    <xsl:with-param name=“id”>FlashList</xsl:with-param>
    <xsl:with-param name=“showMenu”>yes</xsl:with-param>
  <xsl:with-param name=“columns”>
        <columns>
        <column onclick=“goURL(document.all(this.parentElement.id +
‘_Controls’).URL);” id=“FlashName” name=“Flash Name” sortable=“no” field=“FlashName”
titleType=“field” title=“FlashName” length=“30”/>
            <column id=“Flash Bottoms” name=“no” field=“URL”
useTemplates=“yes” sortable=“no” sortType=“no”/>
        </columns>
    </xsl:with-param>
    <xsl:with-param name=“showTitle”>yes</xsl:with-param>
    <xsl:with-param name=“showTransparentSeparator”>no</xsl:with-param>
    <xsl:with-param name=“source”
select=“/PageData/UserPrefs.FlashList/UserPrefs/FlashList”/>
    <xsl:with-param name=“title”>Flash List</xsl:with-param>
    <xsl:with-param name=“showColHeaders”>no</xsl:with-param>
    <xsl:with-param name=“onmouseover”>showEI(this.id + ‘_Controls’);</xsl:with-
param>
    <xsl:with-param name=“onmouseout”>hideVisibleEI(this.id + ‘_Controls’);</xsl:with-
param>
    <xsl:with-param name=“footerContents”>
            <center>
                <input type=“button”
onclick=“Portlets[‘HomePage_Portlet.FlashList’].Submit( );” value=“Save”/>&#xA0;
                <input type=“button”
onclick=“Portlets[‘HomePage_Portlet.FlashList’].Reset( );” value=“Reset”/>
            </center></xsl:with-param>
</xsl:call-template>
```

CommonElements.xsl

Located under \FrontEnd\CPNGWebsite\includes

This family of XSL templates builds common elements of user interface such as calendar control, for example.

DateSelect Template

| Parameter Name | Description |
|---|---|
| content | Mandatory. Presents information about date control |
| | to build. |

content parameter
<date>

| Element | Description/Attributes |
|---|---|
| <date> | Acts as root element. Only element in XML. |
| | Attributes: |
| | @id: Required. Used to add to id and name attributes. |
| | @value: Date formatted for US locale |
| | All attributes that are used by validateForm function such |
| | as description, for example. Exception: fieldtype. |

```
<xsl:call-template name=“DateSelect”>
    <xsl:with-param name=“content”>
        <date id=“CorrectedAdmitDate”
        value=“{$formattedCorrectedAdmitDate}”
description=“Patient Admition Date” required=“yes”/>
    </xsl:with-param>
</xsl:call-template>
```

TimeSelect Template

| Parameter Name | Description |
|---|---|
| content | Mandatory. Presents information about time control |
| | to build. |

content parameter
<time>

| Element | Description/Attributes |
|---|---|
| <time> | Acts as root element. Only element in XML. |
| | Attributes: |
| | @id: Required. Used to add to id and name attributes. |
| | @value: Military time formatted for US locale |
| | All attributes that are used by validateForm function such |
| | as description, for example. Exception: fieldtype. |

```
<xsl:call-template name=“TimeSelect”>
    <xsl:with-param name=“content”>
        <date id=“SomeTime” value=“{$timeVariable}”
        description=“Some time”
required=“yes”/>
    </xsl:with-param>
</xsl:call-template>
```

HiddenCalendar Template

This template creates hidden division that is used as source for popup for DateSelect template. No parameters.

LabelWithEdit Template

This template creates span with info and button aside with “Edit” sign. When press edit sign is transformed to “Save” sign and instead of span edit field appears. And this content will be surrounded by form. Only parameter is content. Internally calls LabelWithEdit template. Contains XML. If this is only editable content use LabelWidthEditForm template instead.

| Parameter Name | Description |
|---|---|
| content | Mandatory. Presents information about in place editing |
| | control to build. |

content parameter
<element>

| Element | Description/Attributes |
|---|---|
| <element> | Acts as root element. Only element in XML. |
| | Attributes: |
| | @id: makes name and id attributes to HTML |
| | @value: initial value to show in span. |
| | @width: minimal initial with of the span. |
| | @form: id of form that this group belongs. Used to |
| | program button for generic submission. |
| | @urlParams: parameters to set to portlet before |
| | submission. |
| | @title: content for HTML title attribute for edit |
| | field and span. |
| | for other attributes see description of validateForm |
| | function. They all can be used and are going to become |
| | input field attributes. |

```
<xsl:call-template name=“LabelWithEdit”>
        <xsl:with-param name=“content”>
            <element id=“EmailAddress”
value=“{/PageData/PtPage.PatientDemographicsGetForPatientNo/row/
@EMailAddress}”
description=“Label With Edit” required=“yes” fieldtype=“email”
width=“100px”
                form=“Summary_Demographics_Form”
portlet=“PtPage_Portlet.Summary_Demographics”
urlParams=“&amp;PatientNo={/PageData/Request/URL/Params/
Param[@name=‘PatientNo’]}” />
        </xsl:with-param>
</xsl:call-template>
```

LabelWithEditForm Template

This template creates span with info and button aside with “Edit” sign. When press edit sign is transformed to “Save” sign and instead of span edit field appears. And this content will be surrounded by form. Only parameter is content. Internally calls LabelWithEdit template. Contains XML. Used when only editable part of portlet

| Parameter | |
|---|---|
| Name | Description |
| content | Mandatory. Presents information about time control to build. |

content parameter
<element>

| Element | Description/Attributes |
|---|---|
| <element> | Acts as root element. Only element in XML. |
| | Attributes: |
| | @id: makes name and id attributes to HTML |
| | @value: initial value to show in span. |
| | @width: minimal initial with of the span. |
| | @form: id of form that this group belongs. Used to |
| | program button for generic submission. |
| | @urlParams: parameters to set to portlet before |
| | submission. |
| | @title: content for HTML title attribute for edit field and |
| | span. |
| | for other attributes see description of validateForm |
| | function. They all can be used and are going to become |
| | input field attributes. |

```
<xsl:call-template name=“LabelWithEditForm”>
  <xsl:with-param name=“content”>
    <element id=“EmailAddress”
value=“{/PageData/PtPage.PatientDemographicsGetForPatientNo/
row/@EMailAddress}”
description=“Label With Edit” required=“yes” fieldtype=“email”
      width=“100px” form=“Summary_Demographics_Form”
portlet=“PtPage_Portlet.Summary_Demographics”
urlParams=“&amp;PatientNo={/PageData/Request/URL/Params/
Param[@name=‘PatientNo’]}” />
  </xsl:with-param>
</xsl:call-template>
```

Cascading Stylesheets
Naming Conventions
Class names should be based on function rather than format or location
   Bad: bluetext, redborder, border4px
   Good: warning, important, submenu
   http://www.w3.orq/QA/Tips/goodclassnames
Class names are Camel-cased, which means that the first character is lowercase and the first letter of any subsequent concatenated words is uppercase.

Style sheet classes have the following structure:

<group><subgroup><class name>

Groups

| Group Name | Description |
|---|---|
| main | Classes that apply to common, non-patient site area |
| patient | |
| content | |
| form | |

Sub Groups

| Sub Group Name | Description |
|---|---|
| header | |
| menu | |
| tab | |
| footer | |

### EXAMPLES

patientTabBackgroundColor
mainHeader
mainMenuHover
mainMenu
mainHeaderDoctorsName
mainHeaderWave
mainHeaderMenu
contentMenuTdLeftRowspan
contentMenuTdRightRowspan
contentMenuSpan
contentMenuSpanSelected
contentMenuTdPosition1NextSep
contentMenuTdPosition1
contentMenuTdPositionLastPrevSep
contentMenuTdPositionLast
contentMenuTdNextSepPrevSep
contentMenuTdNextSep
contentMenuTdPrevSep
contentMenuTd
dropMenuTdLeftRowspan
dropMenuTdRightRowspan
dropMenuSpan
dropMenuSpanSelected
dropMenuTdPosition1NextSep
dropMenuTdPosition1
dropMenuTdPositionLastPrevSep
dropMenuTdPositionLast
dropMenuTdNextSepPrevSep
dropMenuTdNextSep
dropMenuTdPrevSep
dropMenuTd
patientHeaderMenuSpan
patientHeaderMenuSpanSelected
patientHeaderMenuTd
patientHeaderMenuTdLeftRowspan
patientHeaderMenuTdNextSep
patientHeaderMenuTdNextSepPrevSep
patientHeaderMenuTdPosition1
patientHeaderMenuTdPosition1NextSep
patientHeaderMenuTdPositionLast
patientHeaderMenuTdPositionLastPrevSep
patientHeaderMenuTdPrevSep
patientHeaderMenuTdRightRowspan

Stylesheet.js

Located under \FrontEnd\CPNGWebsite\CustomScripts

SkinStyles.js

Located under \FrontEnd\CPNGWebsite\CustomScripts\Skins\[Skin Name]

| Class Name | Description |
|---|---|
| body | |
| div.leftDivision | Left panel on the bottom of the screen |
| div.rightDivision | Right panel on the bottom of the screen |
| div.splitter | Movable panel that is separating left and |
| | right panels |
| div.tabPanel | Right sided bar to represent menu |
| div.mainHeader | Main Header of page with doctors name, |
| | time indicators and main menu |
| tr.mainMenu | First and only row of table that occupies |
| | main header division |
| td.mainHeaderDoctorsName | Three tds that separate content in main |
| | header |
| td.mainHeaderWave | |
| td.mainHeaderMenu | |
| div.mainMenu | Divisions containing menu items for |
| | horizontal menu |
| div.mainMenuHover | Same divisions when mouse is over them |
| td.contentMenuTdLeftRowspan | |
| td.contentMenuTdRightRowspan | |
| span.contentMenuSpan | |
| span.contentMenuSpanSelected | |
| td.contentMenuTdPosition1NextSep | First Item in menu and after it separator is |
| | located |
| td.contentMenuTdPosition1 | First item in menu and no separator follows |
| td.contentMenuTdPositionLastPrevSep | Last Item in menu and before it separator is |
| | located |
| td.contentMenuTdPositionLast | Menu item is located in last position in |
| | menu and no separator on top |
| td.contentMenuTdNextSepPrevSep | Menu item is located between top and |
| | bottom separators |
| td.contentMenuTdNextSep | Menu item is located above separator line |
| td.contentMenuTdPrevSep | Menu item is located below separator line |
| td.contentMenuTd | Menu item that is not located close to |
| | separators or top or bottom of menu. |
| td.dropMenuTdLeftRowspan | See explanations for content table styles |
| td.dropMenuTdRightRowspan | |
| span.dropMenuSpan | |
| span.dropMenuSpanSelected | |
| td.dropMenuTdPosition1NextSep | |
| td.dropMenuTdPosition1 | |
| td.dropMenuTdPositionLastPrevSep | |
| td.dropMenuTdPositionLast | |
| td.dropMenuTdNextSepPrevSep | |
| td.dropMenuTdNextSep | |
| td.dropMenuTdPrevSep | |
| td.dropMenuTd | |
| span.patientHeaderMenuSpan | See explanations for content table styles |
| span.patientHeaderMenuSpanSelected | |
| td.patientHeaderMenu | |
| td.patientHeaderMenutdLeftRowspan | |
| td.patientHeaderMenutdRightRowspan | |
| td.patientHeaderMenuTdNextSep | |
| td.patientHeaderMenuTdNextSepPrevSep | |
| td.patientHeaderMenuTdPosition1 | |
| td.patientHeaderMenuTdPosition1NextSep | |
| td.patientHeaderMenuTdPositionLast | |
| td.patientHeaderMenuTdPositionLastPrevSep | |
| td.patientHeaderMenuTdPrevSep | |
| table.contentOutsideCompartment | Wraps around whole “Quick Table” (table |
| | header, column headers and body) |
| td.contentOutsideHeaderLeftTd | Format “Quick Table” header with |
| | navigation icons, menu icon, collapse icon. |
| td.contentOutsideHeaderRightTd | |
| img.contentOutsideHeaderCoolImageSelected | Control look and feel of table body and |
| | images. |
| | contentOutsideHeaderCoolImage has |
| | invisible border to raise when cursor is |
| | over. Then |
| | img.contentOutsideHeaderCoolImageSelected |
| | is used. Framed image is used when |
| | image has cursor hand. |
| | contentBody CSS classes are used to |
| | control appearance of body of table, |
| | headers of columns and cells. |
| | contentOddOrHoverLine is used for hover |
| | line and to style every other line in wide |
| | tables. |
| img.contentOutsideHeaderCoolImage | |
| img.contentOutsideFramedImage | |
| table.contentBody | |
| th.contentBody | |
| td.contentBody | |
| td.contentOddOrHoverLine | |
| span.mainHeaderTimer | These two CSS classes are used to style |
| | timer on top of the screen. |
| | mainHeadereTimerAlert is used when less |
| | then one minute left before logoff. |
| span.mainHeaderTimerAlert | |
| td.breadCrumbTd | This CSS class is used to style bread |
| | crumbs in the right corner of main header |
| td.patientSearchBegin | These CSS classes are specific to “Folder” |
| | design and used to style search box on to |
| | of main header. |
| td.patientSearchEnd | |
| td.patientSearchMiddle | |
| input.patientSearch | |
| img.contentOutsideHeaderCoolImageSelected | These two classes control image on the |
| | table header that is raising when mouse is |
| | over |
| img.contentOutsideHeaderCoolImage | |
| img.contentOutsideFramedImage | Image that does not raise but has cursor |
| | hand |
| img.contentCoolImageSelected | These two classes control image on the |
| | table content that is raising when mouse is |
| | over |
| img.contentCoolImage | |
| table.contentOutsideCompartment | This class controls overall layout of table |
| | and portlet |
| td.contentOutsideHeaderLeftTd | Those two td classes control look and feel |
| | of header of table and portlet |
| td.contentOutsideHeaderRightTd | |
| table.contentBody | |
| th.contentBody | |
| td.contentBody | |
| td.contentOddOrHoverLine | |
| span.contentBody | This span class is used in column headers |
| | for the column title. It is changed to |
| | span.contentBodySorted class when |
| | content is sorted by this column |
| span.contentBodySorted | Tis class is used for header of column that |
| | is going to be sorted |
| td.transparentSeparator | class for space between tables. Needed to |
| | keep spaces between portlets/quicktables |
| | equally sized |
| div.patientHeader | class for division that surrounds whole |
| | patient header area |
| table.patientHeaderTable | class for table that divides patient header to |
| | compartments and provides space between |
| | them |
| td.patientHeaderFoldingLine | This CSS class controls gradient line on the |
| | left part of patient header |
| td.patientHeaderCompartmentHeader | This CSS class controls left part of patient |
| | compartment header. (It contains title of |
| | compartment) |
| td.patientHeaderCompartmentHeaderRight | This CSS class controls right part of patient |
| | compartment header. (It contains button to |
| | open menu) |
| table.patientHeaderOutsideCompartment | This class has no visual representation. It |
| | is used to pass to QuickTable XSL |
| | template as class for outside table |
| table.patientHeaderBody | This CSS class is passed to QuickTable |
| | template as $class parameter. |
| tr.patientHeaderBody | |
| td.patientHeaderBody | |
| th.patientHeaderBody | |
| td.patientHeaderOddOrHoverLine | This CSS class represents odd lines and |
| | hover lines for patient header content |
| td.patientHeaderPhoto | This CSS class controls photo td |
| portlet | |
| div.portlet | |
| portlet_header | |
| portlet_header_title | |
| portlet_header_item | |
| portlet_filters | |
| main_body | |
| portlet_section | |
| table.portlet_body | |
| tr.portlet_body | |
| th.portlet_body | |
| td.portlet_body | |
| tr.portlet_body_highlight | |
| portlet_footer | |
| portlet_button | |
| menu_parent | |
| menu_parent_highlight | |
| menu_child | |
| divider_line | |

Javascript Libraries

Located under \FrontEnd\CPNGWebsite\scripts.

Open page \FrontEnd\CPNGWebsite\scripts\UnitTests\default.htm to view list of functions and working examples.

Balloon.js

Javascript library with a single function balloonHelp( ) which provides for “balloon-help”, also known as “tool tips”.

| Function Name | Parameters | Return Type | Description |
|---|---|---|---|
| balloonHelp | pstrHelp | None | Provides context-sensitive |
| | pEvent | | help or other content |
| | pintOffsetX | | |
| | pintOffsetY | | |

ButtonCollection.js

ButtonCollection.js is a Javascript object that allows for the assignment and grouping of buttons. Each button has OnMouseOver, OnMouseOut and OnClick events, and the entire set has different display properties to make them act as a single button group.

| Function Name | Parameters | Return Type | Description |
|---|---|---|---|
| ButtonCollection | pstrName | Button | Button Collection object |
| | pstrParentEl | Collection | var myBC = new ButtonCollection( ); |
| | | object | |
| .add | pBtnName | | Add button to collection |
| | plmgBaseName | | myBC.add(“home”, |
| | pWidth | | “Skins/Default/btnHome”, 15, 15, |
| | pHeight | | “Go home”, “alert(‘home’);”, false); |
| | pBtnDisplay | | |
| | pBtnDesc | | |
| | pBtnClick | | |
| | pBtnIsDisabled | | |
| .html( ) | | HTML | Returns HTML block for button |
| | | | collection |
| | | | myBC.html( ) |

Common.js

Common.js is a library of commonly used functions that should be included with every page response.

NULL/Empty Handling Functions

Functions and variables for testing and handling ‘null’ values.

| Function Name | Parameters | Return Type | Description |
|---|---|---|---|
| NULL_DATE | N/A | N/A | Variable that holds a valid “null” Date |
| | | | (1/1/100) |
| isEmpty | pTest | Boolean | Returns true if parameter pTest is |
| | | | “Empty” (null, undefined, empty string, |
| | | | empty array) |
| isNotEmpty | pTest | Boolean | Equivalent to: |
| | | | not isEmpty(pTest) |
| isNotNull | pTest | Boolean | Returns true if parameter pTest is not null |
| isNull | pTest | Parameter | Returns first parameter if it is not |
| | pReplace | | “Empty”, otherwise returns the |
| | | | second parameter |
| isBlank | pstrIn | Boolean | Returns true if string parameter is |
| | | | blank (all spaces or \n or \t) |
| parmStr | pstrParm | String | Returns first parameter if it is not |
| | pstrDefault | | “Empty”, otherwise returns the |
| | | | second string parameter (default is |
| | | | empty string) |
| parmInt | pintParm | Integer | Returns first parameter if it is not |
| | pintDefault | | “Empty”, otherwise returns the |
| | | | second integer parameter (default is |
| | | | 0) |
| parmLng | plngParm | Long | Returns first parameter if it is not |
| | plngDefault | | “Empty”, otherwise returns the |
| | | | second long parameter (default is 0) |
| parmDbl | pdblParm | Double | Returns first parameter if it is not |
| | pdblDefault | | “Empty”, otherwise returns the |
| | | | second double parameter (default is |
| | | | 0.0) |
| parmBln | pblnParm | Boolean | Returns first parameter if it is not |
| | pblnDefault | | “Empty”, otherwise returns the |
| | | | second boolean parameter (default |
| | | | is false) |
| parmDt | pdtParm | Date | Returns first parameter if it is not |
| | pdtDefault | | “Empty”, otherwise returns the |
| | | | second date parameter (default is |
| | | | today) |
| parmObj | pobjParm | Object | Returns first parameter if it is not |
| | pobjDefault | | “Empty”, otherwise returns the |
| | | | second object parameter (default is |
| | | | null) |

Simple “Helper” Functions

Simple Functions that really should have already been in Javascript, or aliases to make the ones that do exist, easier to use.

| Function | | Return | |
|---|---|---|---|
| Name | Parameters | Type | Description |
| minVar | a, b | Parameter | Returns the smaller parameter |
| | | | (accepts numbers, dates, strings) |
| maxVar | a, b | Parameter | Returns the larger parameter |
| | | | (accepts numbers, dates, strings) |
| putStr | pHTML | None | Add content to the current |
| | | | document (alias to the |
| | | | built-in function |
| | | | document.writeIn( )) |
| timerReset | | None | Reset internal timer |
| timerElapsed | | String | Returns time elapsed since timer |
| | | (time) | started |

DOM Manipulation Functions

Functions for obtaining references to DOM elements, and modifying their contents.

| Function Name | Parameters | Return Type | Description |
|---|---|---|---|
| getEl | pID | DOM Element | Obtain a reference to an HTML |
| | | | DOM element by its ID |
| setEl | pID [, pHTML] | | Set a given DOM element's |
| | | | innerHTML to the given HTML |
| | | | fragment string |
| setElURL | pID, pURL | | Set a given DOM element's |
| | | | innerHTML to the resulting HTML |
| | | | fragment obtained from a given URL |
| hideEl | pID | | Hide a given DOM element |
| showEl | pID | | Show a given DOM element |
| toggleEl | pID | | Toggle (show/hide) a given DOM |
| | | | element |
| focusEl | pID | | Set focus to a given DOM element, if |
| | | | it can accept focus |
| getElValue | pID | String | Get the “value” property of a given |
| | | | DOM element, if the element has a |
| | | | “value” (default is null) |
| setElValue | pID, pValue | | Set the “value” property of a given |
| | | | DOM element, if the element has a |
| | | | “value” |
| getOffsetTop | pID | | Get the position of the given |
| | [blnRelativeTo | | element. If no second parameter (or |
| | ParentDIV] | | false) is given, then the position will |
| | | | be calculated from the top of the |
| | | | document, otherwise, the position |
| | | | will be relative to the element's |
| | | | containing “DIV” tag. |
| getOffsetLeft | pID | | Get the position of the given |
| | [blnRelativeTo | | element. If no second parameter (or |
| | ParentDIV] | | false) is given, then the position will |
| | | | be calculated from the left edge of |
| | | | the document, otherwise, the |
| | | | position will be relative to the |
| | | | element's containing “DIV” tag. |
| MoveOver | pstrParentId | | Align child element to parent |
| | pstrChildId | | element. |
| | pstrHorizAlign | | MoveOver(‘divParent’, ‘divChild’, |
| | (left, right, | | ‘left’, ‘bottom’) |
| | center) | | |
| | pstrVertAlign | | |
| | (top, bottom) | | |
| setElXML | pelDest | | Set a given DOM element's |
| | pnodeSrc | | innerHTML to the resulting XHTML |
| | [pblnThorough] | | (XML compliant HTML) obtained |
| | | | from a given XML document/node. |
| setElXMLThorough | pelDest | | Set a given DOM element's |
| | pnodeSrc | | innerHTML to the resulting XHTML |
| | pstrParentNode | | (XML compliant HTML) obtained |
| | Type | | from a given XML document/node. |
| | | | Manual slower method, that loops |
| | | | through all elements. |
| setElXMLText | pstrDestEl | | Set a given DOM element's |
| | pstrXMLSrc | | innerHTML to the XHTML String |
| | [pblnThorough] | | parameter. |
| printEl | pEl | | Print the contents of a given |
| | [pHeader] | | element. This function expects a |
| | [pFooter] | | handle to an element, not just the |
| | | | name. |
| | | | Notice: This function requires the |
| | | | ability to create a pop-up child |
| | | | window. |
| printParentEl | pEl | | Print the contents of a given |
| | pParentNodeType | | element's parent, whose type (tag |
| | [pHeader] | | name) is also given (DIV, TABLE, |
| | [pFooter] | | etc). This function expects a handle |
| | | | to an element, not just the name. |

Common “Window” Functions

Functions relating to the Window object and URLs.

| Function Name | Parameters | Return Type | Description |
|---|---|---|---|
| aryWindows | N/A | | Array of handles to any child pop- |
| | | | up windows that have been |
| | | | created using openWindow( ) |
| aryWindowNames | N/A | | Array of names of any child pop- |
| | | | up windows that have been |
| | | | created using openWindow( ) |
| openWindow | strURL | | Create a pop-up child window, |
| | strWindowName | | based on the parameters |
| | intWidth | | provided |
| | intHeight | | |
| | blnScroll | | |
| showWindows | | | Bring to focus any child windows |
| | | | that have been created using |
| | | | openWindow( ) during this “page” |
| | | | visit |
| closeWindows | | | Close any child windows that |
| | | | have been created using |
| | | | openWindow( ) during this “page” |
| | | | visit |
| openURL | pstrURL | | |
| goURL | pstrURL | | |
| setMsg | pstrMsg | | |
| parseURL | pstrURL, | | |
| | pstrKey | | |
| URLReplaceParam | pstrURL | | |
| | pstrParam | | |
| | pstrNewVal | | |
| keyPress | e | | |
| LoadScript | pstrID | | |
| | pstrURL | | |
| | pblnAsync | | |
| | pstrElType | | |
| | pstrContentType | | |

Base Object Prototype Functions

Functions for manipulating objects.

| Function Name | Parameters | Return Type | Description |
|---|---|---|---|
| copy | pObject | | |
| Object.copyMe | | | |
| Object.newMe | | | |

Date/Time Prototype Functions

Functions for manipulating Date/Time objects.

| | | | |
|---|---|---|---|
| | | Return | |
| Function Name | Parameters | Type | Description |

| | |
|---|---|
| Date.isDate | pstrDate |
| Date.toWeekday | |
| Date.toMonth | |
| Date.toDate | pblnFull |
| | pblnPad |
| Date.toTime | pblnFull |
| Date.toDateTime | pblnFull |
| Date.diff | pstrCompareDate |
| Date.toDateTimeAMPM | pblnFull |
| Date.toDateTime24 HR | pblnFull |
| Date.toDayDateTime | pblnFull |
| Date.setSystemDateTime | pdtToday |
| Date.format | pstrFormat |
| dateDiff | pstrCurrentDate |
| | pstrCompDate |

String Prototype Functions

Functions for manipulating strings.

| | | | |
|---|---|---|---|
| Function Name | Parameters | Return Type | Description |

| | |
|---|---|
| String.repeat | pCount |
| String.ltrim | |
| String.rtrim | |
| String.trim | |
| String.REreplace | pstrFind, |
| | pstrReplace |
| String.wordWrap | pintLength |
| | pstrNewLine |
| String.xmlEncode | |
| String.jsEncode | |
| String.htmlEncode | |

XML Functions

Functions for manipulating XML Objects.

| | | | |
|---|---|---|---|
| Function Name | Parameters | Return Type | Description |

| | |
|---|---|
| getXMLText | pXML |
| | pEI |
| | pDefault |
| getXMLAttribute | pXML |
| | pAttName |
| | pDefault |
| setXMLText | pXML |
| | pstrName |
| | pstrText |
| | pblnEncode |
| setXMLAttribute | pXML |
| | pstrName |
| | pstrText |
| clearXMLChildren | pRoot |
| XML2XHTML | pNode |

Form Functions

Functions for manipulating Forms and Form Controls.

| | | Return | |
|---|---|---|---|
| Function Name | Parameters | Type | Description |
| generateFormXML | pFormName, | None | Loop form fields and |
| | pTargetNode | | create the following XML |
| | | | structure under the |
| | | | node pTargetNode: |
| | | | <form name= |
| | | | “[formName]”> |
| | | | <field |
| | | | name=“”>[fieldValue] |
| | | | </field> |
| | | | <field |
| | | | name=“”>[fieldValue] |
| | | | </field> |
| | | | (...) |
| | | | </form> |

DIVSelect.js

DlVSelect.js is a Javascript object that functions similarly to a drop-down combo or a list box, but is made purely in DHTML and does not cause “div overlay” display issues like the core windows objects.

DIVSelectXML.js

ErrorHandler.js

| | | | |
|---|---|---|---|
| Function Name | Parameters | Return Type | Description |

| | |
|---|---|
| HandleError | pException |
| ParseError | pException |
| AppError | pSource |
| | pNumber |
| | pMessage |
| | pInnerException |

GGELoadData.js

Generic Grid Editor (e.g. admin changes to lookup tables)

GGEUpdateData.js

MD5.js

Encryption of passwords and validating digital signatures.

Portlets.js

Portlet “Object” definition.

Quizlet_Util.js

Quizlets functions.

Stylesheet.js

TableSelect.js

TableSelect.js is a Javascript object that allows for parent/child row selections. The TableSelect object is given table entries that are either parent or child entities, and can have multiple cells. Expand/collapse and navigational methods exist as well.

TimeoutMapper.js

XMLMapper.js

XMLMapper.js is a Javascript object that allows for the loading and “mapping” of XML documents. Any XML documents to be loaded within the application will be loaded using the XMLMapper object.

FormValidation.js

Contains a single function validateForm, to automate client-side form validation.

| Function | | | |
|---|---|---|---|
| Name | Description | Parameters | Return Type |
| validateForm | Validate all the fields | pForm | Boolean |
| | of the form and | pCustomErrorMsg | |
| | display alert with | | |
| | validation error | | |
| | messages | | |

HMTL Field Attributes

| Attribute | Description |
|---|---|
| description | Field description to be displayed on the validation error message |
| fieldType | Optional. The field data type. See table below for the possible |
| | values. When fieldType is not entered, it defaults to ‘free format’. |
| | Other attributes such as required, min, max may be entered without |
| | a fieldType. |
| required | Optional. Determine if field is required. Values: yes, no (default). |
| groupRequired | Optional. When set for two or more fields, one (and only one) must |
| | be entered. Values: yes, no (default). |
| min | Optional. When the fieldtype is numeric or date: minimum value of |
| | field. When the fieldtype is alpha or not entered: minimum number |
| | of characters. When the HTML control is a multiple-select list: |
| | minimum number of selected items. |
| max | Optional. When the fieldtype is numeric or date: maximum value of |
| | field. When the fieldtype is alpha or not entered: maximum number |
| | of characters. When the HTML control is a multiple-select list: |
| | maximum number of selected items. |
| minDescription | Optional. When min attribute is entered: description to be displayed |
| | on the validation error message instead of min value |
| maxDescription | Optional. When max attribute is entered: description to be displayed |
| | on the validation error message instead of max value |
| customRegExp | Optional. When fieldtype is Custom: regular expression to be tested |
| customRegExpMsg | Optional. When fieldtype is Custom: error message when regular |
| | expression test fails |

### EXAMPLES

Required Field (free format):
<input type=”text” name=”LastName” description=”Last Name”
required=”yes” />
Alpha with size range:
<input type=”text” name=”FirstName” description=”First Name”
fieldType=”Alpha” min=”20” />
Date:
<input type=”text” name=”EndDate” description=”End Date”
fieldType=”Date” />
Custom:
<input type=“text” name=“CustomField” fieldtype=“Custom”
description=“Custom Field” customRegExp=“\hat{ }G”
customRegExpMsg=“‘%fld1’ must start with ‘G’.” />
fieldtype Values

| Parameter | Description |
|---|---|
| Number | Number in the format 999 or −999 or −9.99 or |
| | 9.99 |
| PosNumber | Positive number in the format 999 or 9.99 |
| NegNumber | Negative number in the format 999 or 9.99 |
| Integer | Integer in the format 999 or −999 |
| PosInteger | Positive integer in the format 999 |
| NegInteger | Negative integer in the format −999 |
| Money | Monetary value in the format 9.99 |
| | (positive with exactly two decimals) |
| Alpha | Characters A-Z |
| AlphaSpace | Characters A-Z and spaces |
| AlphaUnderscore | Characters A-Z and underscores |
| AlphaNum | Characters A-Z and numbers 0-9 |
| AlphaNumSpace | Characters A-Z, numbers 0-9 and spaces |
| AlphaNumUnderscore | Characters A-Z, numbers 0-9 and underscores |
| Date | Date in the format mm/dd/yy[yy] |
| DateTime | Date/Time in the format mm/dd/yy[yy] hh:mm |
| | {AM/PM} (12 or 24 hour pattern) |
| MonthYear | Date in the format mm/yy[yy] |
| Year | Year in the format yyyy |
| Time | Time in the format hh:mm {AM/PM} or hh:mm |
| Phone | Complete Phone Number in the format |
| | 999-999-9999, (999) 999-9999 or 9999999999. |
| PhoneAreaCode | Area Code in the format 999 |
| PhoneExchange | Phone Exchange in the format 999 |
| PhoneNumber | Individual Subscriber Phone Number in the |
| | format 9999 |
| SSN | SSN in the format 999-99-9999 or 999999999 |
| Zip | Zip code in the format 99999 or 99999-9999 |
| URL | Web address in the format XXX.XXX |
| Email | Email in the format name@domain.extension. |
| | Name, domain, or extension should be at least 2 |
| | characters, may contain letters, periods, |
| | underscore or hyphen, should start with a |
| | character, and cannot end with a special character |
| Image | Files with .GIF, .JPEG or .JPG extensions |
| Custom | Custom regular expression. Must also set |
| | attributes customRegExp and customRegExpMsg |

```
<script type=“text/javascript” language=“JavaScript”
src=“FormValidation.js”></script>
<script language=“javascript”>
  function submitForm( ) {
    if (validateForm(document.formValidation))
      alert(‘Form is Valid!’);
  }
</script>
<form name=“formValidation” method=“post”>
  <input type=“text” name=“Comment” required=“true”
  description=“Comment” />
  <a href=“javascript:submitForm( );”>Submit</a>
</form>
```

### EXAMPLE

Throughout this application, author and year and patents by number reference various publications, including United States patents. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used, is intended to be in the nature of words of description rather than of limitation.

Obviously, many modifications and variations of the present invention are possible in light of the above teachings. It is, therefore, to be understood that within the scope of the described invention, the invention may be practiced otherwise than as specifically described.

What we claim is:

1. A system for processing a request, said system comprising:
request initiation means for creating a request;
request receiving means for receiving the request from said request initiation means, said request receiving means in communication with said request initiation means; and
data structuring means for sequencially structuring data for use in processing the request and providing a response to the request.

2. The system according to claim 1, wherein said data structuring means includes:
request processing means for receiving and processing the request; and
output processing means for processing the result.

3. The system according to claim 2, wherein said output processing means further includes analysis means for analyzing the output and determining programs to run in order to achieve the outcome and an order in which to run the programs in order to achieve the outcome.

4. The system according to claim 1, wherein said system if software.

5. The system according to claim 4, wherein said software is written in a language selected from the group consisting essentially of C#, XSL, SQL, and HTML.

6. The system according to claim 1, further including security means for securing said system and preventing unauthorized access to said system.

7. The system according to claim 6, wherein said security means is selected from the group consisting essentially of a PIN, an access code, a password, and a URL with an identification number.

8. The system according to claim 1, wherein said system includes remote access means for remotely accessing said system.

9. The system according to claim 8, wherein said remote access means is selected from the group consisting essentially of modem, a wide area network, a local area network, and a telephone.

10. A method of processing a request by:
creating a request;
forwarding the request to a request processing system;
receiving the request;
processing the request;
processing the output of the request; and
providing a response to the request.

11. The method according to claim 10, wherein said output processing step includes:
determining programs to run for processing the output; and
determining an order for running the programs in order to effectuate the response.

12. The method according to claim 11, wherein said program determining step includes configuring files to process the request.

13. The method according to claim 11, further including limiting access to the system using a security device.

14. A computer program for processing a request, said program comprising:
request initiation means for creating a request;
request receiving means for receiving the request from said request initiation means, said request receiving means in communication with said request initiation means; and
data structuring means for sequencially structuring data for use in processing the request and providing a response to the request.

15. The program according to claim 14, wherein said data structuring means includes:
request processing means for receiving and processing the request; and
output processing means for processing the result.

16. The program according to claim 15, wherein said output processing means further includes analysis means for analyzing the output and determining programs to run in order to achieve the outcome and an order in which to run the programs in order to achieve the outcome.

17. The program according to claim 14, wherein said program is written in a language selected from the group consisting essentially of C#, XSL, SQL, and HTML.

18. The program according to claim 14, further including security means for securing said program and preventing unauthorized access to said program.

19. The program according to claim 18, wherein said security means is selected from the group consisting essentially of a PIN, an access code, a password, and a URL with an, identification number.

20. The program according to claim 14, wherein said program includes remote access means for remotely accessing said program.

21. The program according to claim 20, wherein said remote access means is selected from the group consisting essentially of modem, a wide area network, a local area network, and a telephone.
